(19) United States
(12) Patent Application Publication
(10) Pub. No.: US 2013/0282434 A1
(43) Pub. Date: Oct. 24, 2013

(54) METHODS AND APPARATUS TO MANAGE MARKETING FORECASTING ACTIVITY

(71) Applicants: Bruce C. Richardson, Arlington Heights, IL (US); Larry Menke, Chicago, IL (US); Martin Quinn, Sugar Grove, IL (US); Jonathan Poeder, Chicago, IL (US)

(72) Inventors: Bruce C. Richardson, Arlington Heights, IL (US); Larry Menke, Chicago, IL (US); Martin Quinn, Sugar Grove, IL (US); Jonathan Poeder, Chicago, IL (US)

(21) Appl. No.: 13/451,748

(22) Filed: Apr. 20, 2012

(51) Int. Cl. G06Q 30/02

(52) U.S. Cl. 705/7.31

(57) ABSTRACT

Methods and apparatus are disclosed to manage marketing forecasting activity. An example method includes retrieving client driver control data and corresponding market triggers, generating a client baseline profile associated with the client based on the client driver control data and a corresponding market trigger, calculating a first probability of not taking action when action prevents a missed marketing objective, calculating a second probability of taking action when action causes superfluous spending to meet a marketing objective, and generating the alert based on a comparison between the product of the first probability and a cost of the missed marketing objective and the product of the second probability and a cost of the superfluous spending.

### FIELD OF THE DISCLOSURE

This disclosure relates generally to market research, and, more particularly, to methods and apparatus to manage marketing forecasting activity.

### BACKGROUND

In recent years, marketing models have been developed to identify reasons explaining sales changes and/or to forecast client sales activity during future time-periods of interest. Responses to one or more marketing campaigns may result in a volume change for the client, such as an increase in sales associated with a client product and/or service targeted by the campaign(s). In some examples, marketing campaigns performed by one or more competitors has an effect on both the competitor sales values and client sales values. Generally speaking, a campaign may include a group of related causals and/or drivers, in which an example driver effects a channel of a marketing category. A decomposition of a marketing model is an analysis of marketing drivers (e.g., a channel of a marketing category such as television advertising, print advertising, online advertising, public relations, coupons and/or in-store promotions) and corresponding effects on sales.

### BRIEF DESCRIPTION OF THE DRAWINGS

FIG. 1 is a schematic illustration of a system to manage marketing forecasting activity in accordance with the teachings of this disclosure.

FIGS. 2, 5, 11, and 12 are flowcharts representative of example machine readable instructions which may be executed to manage marketing forecasting activity.

FIG. 3 is a schematic illustration of an example driver identifier of the example system of FIG. 1.

FIG. 4 is an example driver forecast aggregation graph generated by the example system of FIG. 1.

FIG. 6 is a schematic illustration of an example alerting engine of the example system of FIG. 1.

FIGS. 7, 9A and 9B are an example forecast plots generated by the example system of FIG. 1.

FIG. 8 is a schematic illustration of an example net-loss engine of the example system of FIG. 1.

FIG. 10 is an example alerting threshold pain threshold plot generated by the example system of FIG. 1.

FIG. 13 is a schematic illustration of an example graphical user interface engine of the example system of FIG. 1.

FIGS. 14A-14C are example screenshots generated by the example graphical user interface engine of FIG. 13 and the example system of FIG. 1.

FIG. 15 is a schematic illustration of an example processor platform that may execute the instructions of FIGS. 2, 5, 11 and 12 to implement the example systems and apparatus of FIGS. 1, 3, 6, 8 and 13.

### DETAILED DESCRIPTION

Market researchers may generate any number of sales forecasts in an effort to predict one or more market behaviors. In some examples, the sales forecasts illustrate that one or more marketing initiatives and/or marketing targets are either on-track with target expectations or falling-below target expectations (e.g., total sales, volume sales, category market share, geography market share, etc.). Marketing initiatives/targets that are on-track may be referred to as “sunny-day” conditions. On the other hand, marketing initiatives/targets that are falling below expectations may be referred to as “rainy-day” conditions. In the event a forecast illustrates that one or more marketing targets are falling-below expectations, the market researchers may recommend and/or otherwise initiate one or more additional and/or alternate marketing initiatives to bolster lethargic performance.

In response to lethargic performance of a marketing initiative (e.g., for a product), the market researcher may choose to expend additional investment toward advertising initiatives, distribution initiatives, new market penetration, promotional campaigns, etc. While initiating such additional initiatives requires an expenditure of money and/or investment of resources, a corresponding market improvement in terms of increased sales volume, increased sales revenue and/or increased market share may result to offset the investment. In some examples, the additional invested initiatives result in sales and/or performance improvements (e.g., increased profits, increased market share, etc.) that outweigh associated costs for the additional initiatives.

While the market researcher (e.g., a manufacturer, a retailer, etc.) may generate one or more forecasts, may generate one or more target expectations/goals, and/or may monitor market performance to verify compliance with the target expectations, the market researcher may not appreciate when corrective action should be taken at a time early enough to reverse or eliminate the shortfall. For example, even in the event that a market forecast indicates product market performance will align with a target expectation at a first time, changes may develop and/or otherwise occur in the market which result in a missed target at a second (later) time. If the market researcher waits too long between repeated analyses and/or reviews of the forecast in view of the target, corrective action may be more expensive, ineffective and/or difficult to implement. Disparity between a market forecast and a target goal may occur based on competitive activity, such as competitive price drops, competitive advertising and/or the introduction of new/additional competitive product(s).

Example methods, systems, apparatus and articles of manufacture disclosed herein generate and/or receive sales forecasts, compare such forecasts to planned sales targets, and assess a likelihood of deviating from the plan. Additionally, example methods, systems, apparatus and/or articles of manufacture disclosed herein generate alerts in view of expected missed targets based on historical client behaviors, and generate one or more user interfaces to reveal relevant drivers responsible for the alerts.

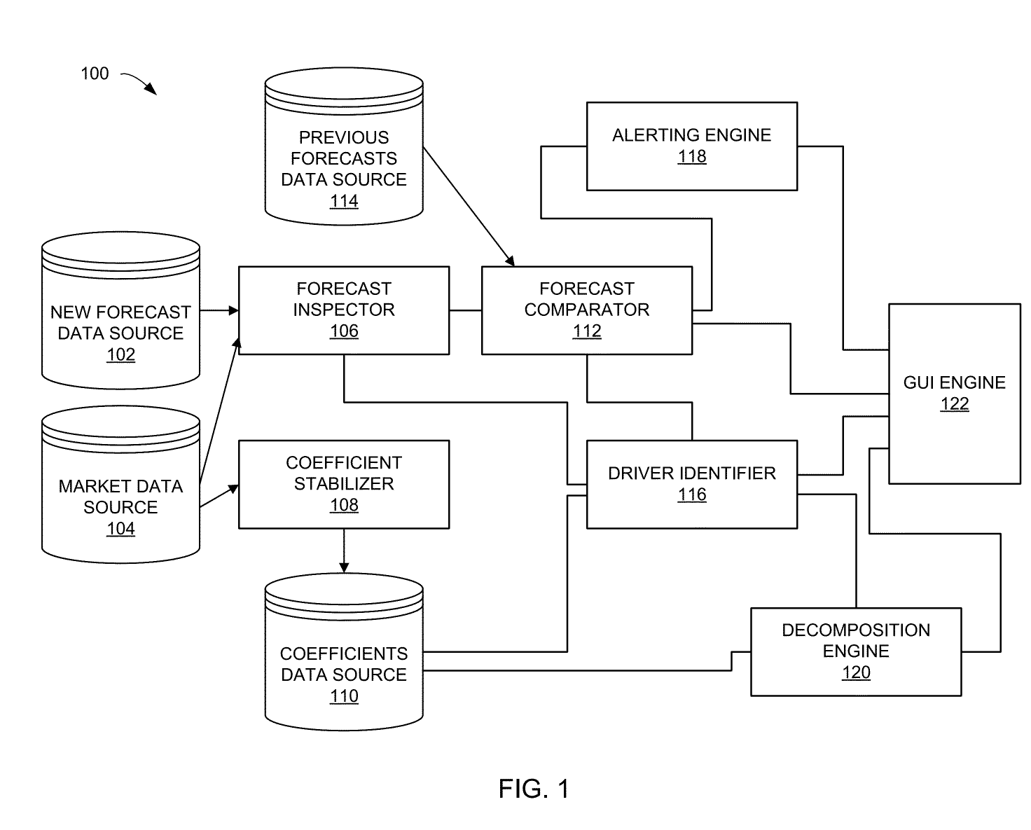

FIG. 1 is a schematic illustration of a system 100 to manage marketing forecasting activity. In the illustrated example of FIG. 1, the system 100 includes a new forecasts data source 102, a market data source 104, a forecast inspector 106, a coefficient stabilizer 108, a coefficient data source 110, a forecast comparator 112, a previously used forecasts data source 114, a driver identifier 116, an alerting engine 118, a decomposition engine 120 and a graphical user interface (GUI) engine 122. In operation, the example forecast inspector 106 receives and/or otherwise retrieves one or more forecasts stored in the example new forecasts database 102. The one or more forecasts may be developed by product manufacturers, analysts, market researchers and/or any other entity chartered with a responsibility of developing market forecasts. Generally speaking, a market forecast (e.g., a sales forecast, a driver forecast, etc.) is an educated guess related to expected performance of one or more products and/or services. The market forecast may be generated by implementing one or more statistical and/or other mathematical techniques in view of market data, such as market data stored in the example market data data source 104. The example market data source 104 may include publicly available information such as U.S. Census Bureau data, and/or data cultivated by market research entities. Example market data sources 104 may include, but are not limited to Nielsen® Homescan® data, Nielsen® TDLinx® data, Nielsen® product reference library (PRL) and/or point-of-sale (POS) data from retailers and/or merchants.

The example market forecasts may include both sales forecasts and driver forecasts. A driver, such as an independent variable controlled and/or otherwise manipulated during a marketing campaign, may include price, distribution, all commodities volume (ACV), percent trade promotion, etc. In other words, as used herein a driver is one or more actions and/or events that may affect market behavior, such as affecting a volume of sales for a product. While a product manufacturer may control, attempt to control and/or otherwise influence one or more drivers associated with a product of interest, some drivers that affect market behavior are outside the control of the product manufacturer. Competitor temporary price reduction (TPR) activity, for example, is one driver beyond the control of the product manufacturer that may affect market behavior.

A sales forecast may include a monetary or volumetric magnitude profile over one or more time periods. A question of interest to market analysts is which driver and/or plurality of drivers is/are responsible for a corresponding sales forecast. Typically, the number of drivers that is either controlled by the manufacturer/retailer and/or occurs outside the control of a product manufacturer/retailer is large, thereby making identification of the most relevant driver(s) difficult.

The example forecast inspector 106 separates sales forecasts from driver forecasts stored in the example new forecasts data source 102. Additionally, the example forecast inspector 106 sends and/or otherwise makes available the sales forecasts to the example forecast comparator 112, and sends and/or otherwise makes available the driver forecasts to the example driver identifier 116. While the quantity of available sales forecasts in the example new forecasts data source 102 may be relatively large, the example forecast comparator 112 inspects the integrity of the available sales forecasts to eliminate those that fail to meet one or more statistical standards and/or best practices. The remaining sales forecasts are compared by the example sales forecast comparator 112 to previously used sales forecasts stored in the example previous sales forecasts data source 114. For those new sales forecasts that are similar to previously used sales forecasts, an indication of success associated with the previously used sales forecast is imputed to one or more corresponding new sales forecasts. For example, in the event a first sales forecast that was previously used resulted in a relatively high accuracy when compared with subsequent market performance data, then that first sales forecast may be assigned a weighted value proportional to its degree of historical success and/or consistency. On the other hand, if an example second forecast that was previously used resulted in a relatively low accuracy when compared with subsequent market data, then the second sales forecast may be assigned a weighted value proportionally and/or relatively lower than the first sales forecast. The example forecast comparator 112 may select one sales forecast based on the highest relative weight.

Types of forecasting techniques may include, but are not limited to linear regression, exponential smoothing, Theta, autoregressive integrated moving average (ARIMA), ARIMA with a transfer function and/or unspecified components models. For example, in the event a previously used forecast resulted in a relatively poor ability to predict (e.g., based on empirical observations since the time it was first used), then the corresponding new forecast is removed from consideration. On the other hand, in the event a previously used forecast resulted in a relatively good degree of accuracy when predicting future product performance, then the corresponding new forecast (having similar qualities and/or statistical techniques) is maintained for consideration for current use.

The example forecast comparator 112 selects a sales forecast from the remaining candidates using any number and/or types of vetting techniques. One or more business rules may be employed that identify sales forecasts to eliminate from further consideration. For example, if a candidate sales forecast is 200% higher than any forecast historically observed, then the example forecast comparator may deem that as a wild forecast for removal. In the illustrated example, vetted sales forecast is sent by and/or otherwise made available to the example alerting engine 118, the example driver identifier 116 and the example GUI engine 122. As described in further detail below, the example alerting engine 118 generates one or more alerts that inform the market researcher when the vetted sales forecast will miss and/or exceed one or more targets. Issued alerts include a likelihood of sales/share exceeding or missing the target. Additionally, the example alerting engine 118 may generate one or more alerts that inform the market researcher when the vetted sales forecast will exceed one or more targets. When generating one or more alarms for the market researcher based on the vetted sales forecast, the example alerting engine may employ one or more methods/techniques, such as confidence limit boundary assessment, probability value assessment and/or logit assessment analysis.

In still other examples, the alerting engine 118 generates one or more alerts consistent with historical sensitivities of the market researcher (or a client of the market researcher, such as a manufacturer, a brand manager, a retail chain manager, etc.). For instance, some market researchers historically react (e.g., by spending money and/or resources on one or more campaigns to capture market share, such as advertising, price discounts, distribution adjustments, etc.) to a relatively slight possibility that one or more targets would be missed by a sales forecast. For such market researchers, the example alerting engine 118 establishes one or more confidence limits to cause one or more alerts to occur sooner (e.g., more sensitive confidence limits). On the other hand, other market researchers historically endure periods of market share loss without reacting (e.g., a less sensitive market researcher). For such less sensitive market researchers, the example alerting engine 118 establishes one or more confidence limits to cause one or more alerts to occur later. In other words, a greater magnitude of sales loss or decreasing market share will occur before the example alerting engine 118 issues one or more alerts to a less sensitive researcher.

Some market researchers may not be fully aware of historical decision markers (e.g., a particular percentage drop in market share) in response to fluctuating market performance for one or more products of interest. In other words, the market researchers may not be aware of one or more particular market measurements and/or thresholds thereof that should prompt a responsive action. Methods, apparatus, systems and/or articles of manufacture disclosed herein capture and/or otherwise aggregate historical driver control activities by an organization to identify trends and/or reactive organizational behaviors of the organization in response to market changes. Market changes may include, but are not limited to sales volume changes, market share changes and/or competitive product penetration attempts. Additionally, historical driver control activities that occur in response to such market changes may include, but are not limited to promotions, price reductions, advertisements and/or new product introductions, such as those initiated by one or more competitors.

The example forecast comparator 112 of FIG. 1 also provides the vetted sales forecast to the example driver identifier 116. As described in further detail below, the example driver identifier 116 manages the relatively vast number of driver forecasts to determine the best and/or otherwise most likely driver forecasts that correspond to the vetted sales forecast. For example, each driver type could have any number of candidate forecasts (e.g., ten price driver forecasts, twenty distribution driver forecasts, etc.). An analyst may use a mathematical model to estimate how a driver affects sales volumes based on a selected vetted sales forecast (e.g., a sales forecast model). An example model includes a regression model to relate sales volumes to the one or more drivers and generate one or more coefficients. However, because driver forecasts and driver types can be numerous, performing a regression-based analysis on all available driver forecasts is computationally impractical. To establish which plurality of driver forecasts best represent the vetted sales forecast, the example driver identifier 116 of FIG. 1 employs stabilized coefficients from the example coefficient data source 110 and identifies groupings/clusters of drivers that exhibit distinct trends.

Generally speaking, driver forecasts are analogous to opinions regarding market behavior, in which some driver forecasts include fluctuations (e.g., seasonal fluctuations), some do not, some driver forecasts trend upwards, some downwards, and other driver forecasts describe neither increasing nor decreasing trends. Additionally, because driver forecasts and driver types are abundant in number (e.g., drivers related to gross domestic product (GDP), drivers related to consumer price index (CPI), drivers related to unemployment, drivers related to short term interest rates, drivers related to advertising initiatives (competitor and non-competitor), competitor distribution, etc.), attempting to employ each driver forecast in a regression model with the sales forecast is computationally impractical. Instead, and as described in further detail below, the example driver identifier 116 of FIG. 1 applies a Euclidian distance technique to identify clusters of similarly trending driver forecasts to generate forecast clusters. Each distinct cluster may be further analyzed in view of historical likelihood and magnitude of sales factors to select a surrogate driver. A finite number of surrogate drivers from different clusters may be selected to generate a manageable number of permutations so that a combination of drivers may be selected that best describes the vetted sales forecast.

The alerts generated by the example alerting engine 118, the vetted forecast, the combination of driver forecasts and decomposed driver data are provided to the example GUI engine 122 to generate one or more GUIs to allow the market researcher to view alerting details. Alerting details may include, but are not limited to geographically-based alerts, category-based alerts and/or brand-specific alerts. Additionally, each alert may employ the driver decomposition information to reveal candidate reasons that the alert is occurring and/or is expected to occur at one or more future dates.

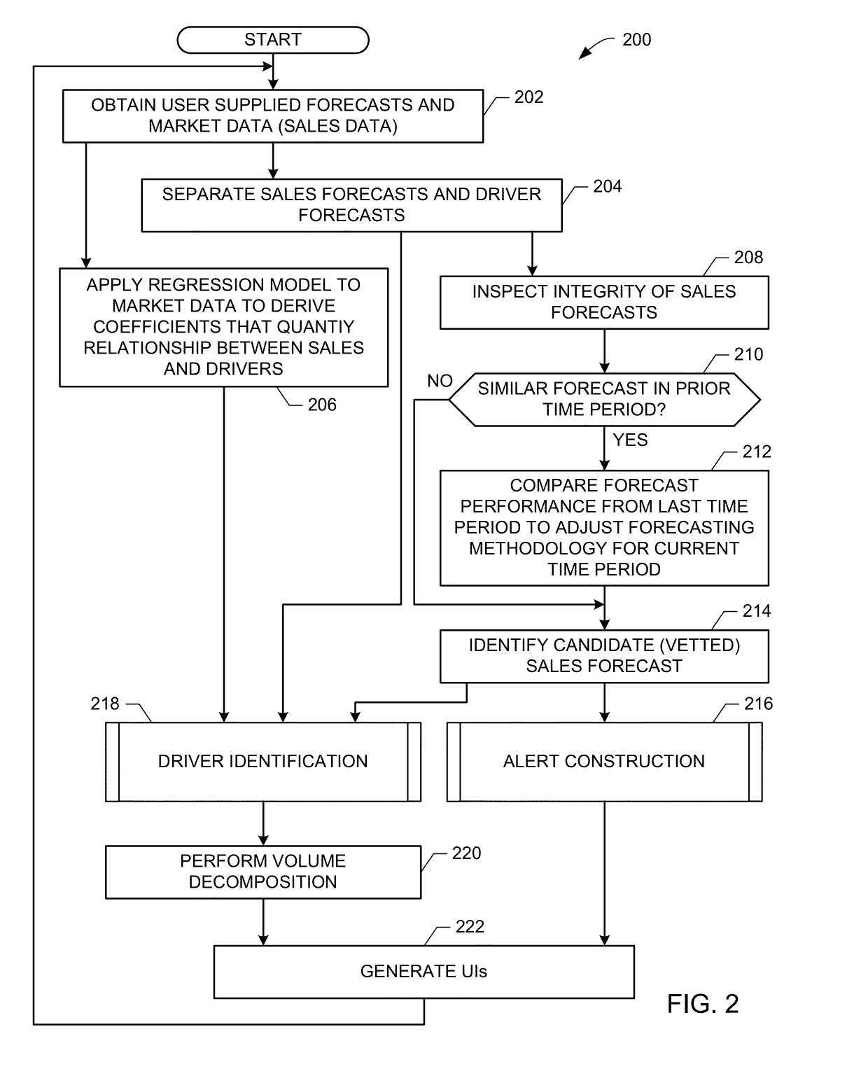

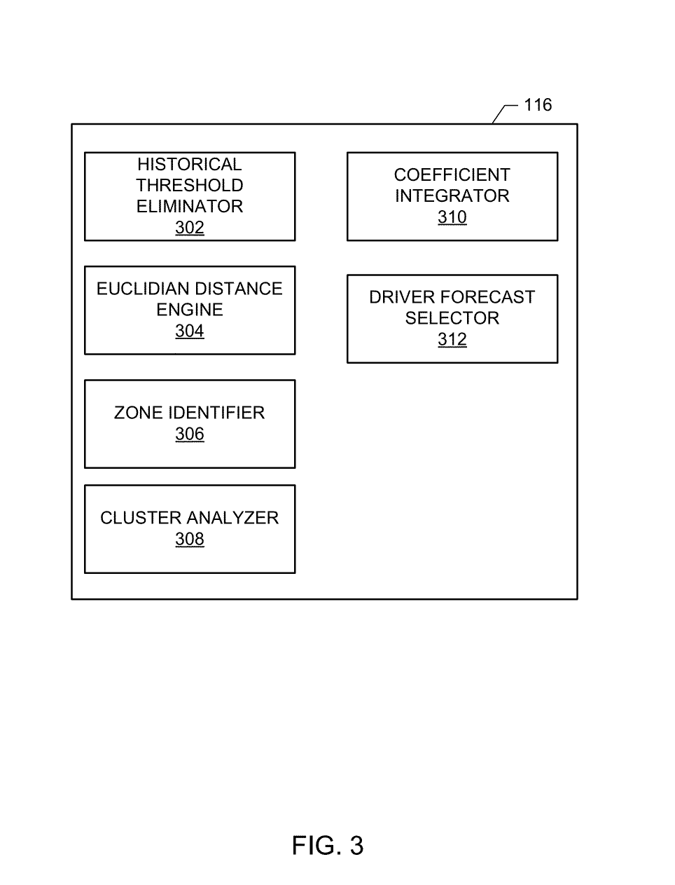

While an example manner of implementing the system to manage forecasting activity 100 has been illustrated in FIG. 1 and, as described in further detail below, FIGS. 2-8, 9A, 9B, 10-13, 14A-C and 15, one or more of the elements, processes and/or devices illustrated in FIGS. 1-8, 9A, 9B, 10-13, 14A-C and 15 may be combined, divided, re-arranged, omitted, eliminated and/or implemented in any other way. Further, the example new forecasts data source 102 (e.g., a database), the example market data source 104 (e.g., a database), the example forecast inspector 106, the example coefficient stabilizer 108, the example coefficients data source 110 (e.g., a database), the example forecast comparator 112, the example previous forecasts data source 114 (e.g., a database), the example driver identifier 116, the example alerting engine 118, the example decomposition engine 120 and/or the example GUI engine 122 of FIG. 1 may be implemented by hardware, software, firmware and/or any combination of hardware, software and/or firmware. Additionally, and as described below, the example historical threshold eliminator 302, the example Euclidian distance engine 304, the example zone identifier 306, the example cluster analyzer 308, the example coefficient integrator 310, the example driver forecast selector 312, the example plot generator 602, the example confidence limit extractor 604, the example target integrator 606, the example alerting methodology manager 608, the example net loss engine 610, the example client history manager 802, the example action probability engine 804, the example alerting level manager 806, the example data set retriever 1302, the example geography zone manager 1304, the example category manager 1306, the example icon manager 1308, the example decomposition interface 1310, and/or the example alert interface 1312 of FIGS. 3, 6, 8 and 13 may be implemented by hardware, software, firmware and/or any combination of hardware, software and/or firmware. Thus, for example, any of the example new forecasts data source 102 (e.g., a database), the example market data source 104 (e.g., a database), the example forecast inspector 106, the example coefficient stabilizer 108, the example coefficients data source 110 (e.g., a database), the example forecast comparator 112, the example previous forecasts data source 114 (e.g., a database), the example driver identifier 116, the example alerting engine 118, the example decomposition engine 120 and/or the example GUI engine 122, the example historical threshold eliminator 302, the example Euclidian distance engine 304, the example zone identifier 306, the example cluster analyzer 308, the example coefficient integrator 310, the example driver forecast selector 312, the example plot generator 602, the example confidence limit extractor 604, the example target integrator 606, the example alerting methodology manager 608, the example net loss engine 610, the example client history manager 802, the example action probability engine 804, the example alerting level manager 806, the example data set retriever 1302, the example geography zone manager 1304, the example category manager 1306, the example icon manager 1308, the example decomposition interface 1310, and/or the example alert interface 1312 of FIGS. 1, 3, 6, 8 and 13 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example new forecasts data source 102 (e.g., a database), the example market data source 104 (e.g., a database), the example forecast inspector 106, the example coefficient stabilizer 108, the example coefficients data source 110 (e.g., a database), the example forecast comparator 112, the example previous forecasts data source 114 (e.g., a database), the example driver identifier 116, the example alerting engine 118, the example decomposition engine 120, the example GUI engine 122, the example historical threshold eliminator 302, the example Euclidian distance engine 304, the example zone identifier 306, the example cluster analyzer 308, the example coefficient integrator 310, the example driver forecast selector 312, the example plot generator 602, the example confidence limit extractor 604, the example target integrator 606, the example alerting methodology manager 608, the example net loss engine 610, the example client history manager 802, the example action probability engine 804, the example alerting level manager 806, the example data set retriever 1302, the example geography zone manager 1304, the example category manager 1306, the example icon manager 1308, the example decomposition interface 1310, and/or the example alert interface 1312 of FIGS. 1, 3, 6, 8 and 13 are hereby expressly defined to include a tangible computer readable storage medium such as a memory, DVD, CD, Blu-ray, etc. storing the software and/or firmware. Further still, the example system 100 of FIG. 1 may include one or more elements, processes and/or devices in addition to, or instead of, those illustrated in FIGS. 1, 3, 6, 8 and 13, and/or may include more than one of any or all of the illustrated elements, processes and devices.

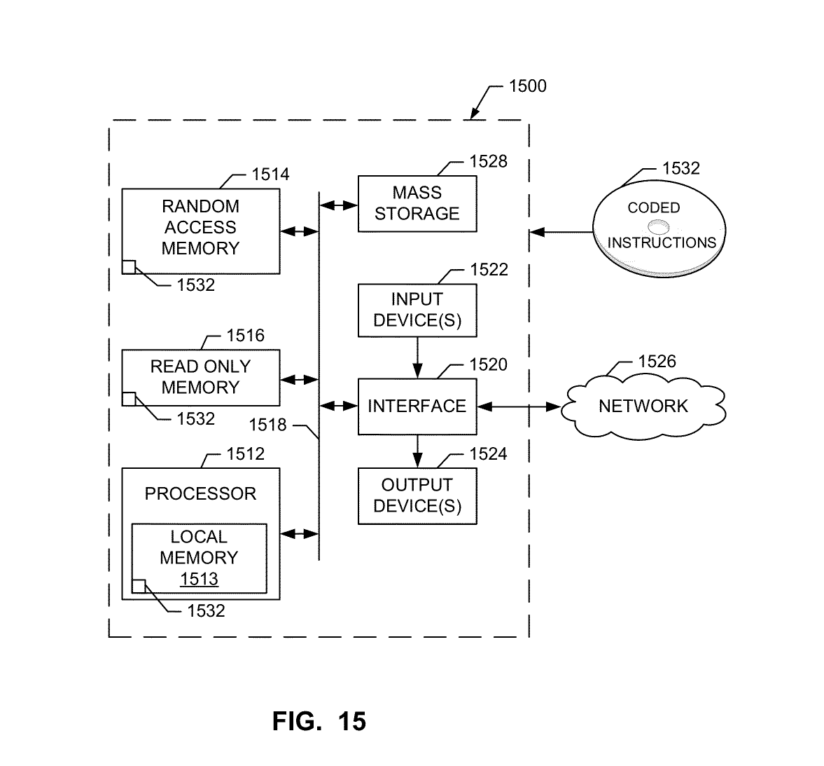

Flowcharts representative of example machine readable instructions for implementing the system 100 of FIGS. 1, 3, 6, 8 and 13 are shown in FIGS. 2, 5, 11 and 12. In this example, the machine readable instructions comprise a program for execution by a processor such as the processor 1512 shown in the example computer 1500 discussed below in connection with FIG. 15. The program may be embodied in software stored on a tangible computer readable storage medium such as a CD-ROM, a floppy disk, a hard drive, a digital versatile disk (DVD), a Blu-ray disk, or a memory associated with the processor 1512, but the entire program and/or parts thereof could alternatively be executed by a device other than the processor 1512 and/or embodied in firmware or dedicated hardware. Further, although the example program is described with reference to the flowcharts illustrated in FIGS. 2, 5, 11 and 12, many other methods of implementing the example system 100 to manage marketing forecasting activity may alternatively be used. For example, the order of execution of the blocks may be changed, and/or some of the blocks described may be changed, eliminated, or combined.

As mentioned above, the example processes of FIGS. 2, 5, 11 and 12 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable storage medium is expressly defined to include any type of computer readable storage and to exclude propagating signals. Additionally or alternatively, the example processes of FIGS. 2, 5, 11 and 12 may be implemented using coded instructions (e.g., computer readable instructions) stored on a non-transitory computer readable storage medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable storage and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The program 200 of FIG. 2 begins at block 202 where the example forecast inspector 106 obtains user supplied forecasts (e.g., sales forecasts and driver forecasts) and market data (e.g., sales data). Sales forecasts are separated from driver forecasts by the example forecast inspector 106 (block 204). The sales forecasts are sent and/or otherwise made available to the example forecast comparator 112. The driver forecasts are also sent and/or otherwise made available to the example driver identifier 116. The market data from the example market data database 104 is sent to and/or otherwise made available to the example coefficient stabilizer 108. One or more regression models are applied to the received market data by the example coefficient stabilizer 108 to derive coefficients that quantify relationships between sales data and driver data (block 206). The one or more regressions executed by the one or more regression models may be used to establish priors with prior data/results and business judgment. Additionally, a Markov Chain Monte Carlo (MCMC) procedure may be employed to generate coefficients. MCMC employs Bayesian techniques, which may be used to help establish stable coefficients, and to allow more drivers than the number of observations will typically allow. Further, MCMC may further extend Bayesian techniques by allowing coefficient thresholds to aid in keeping the relationship between sales and drivers within one or more judgment rules. In still other examples, Bayesian stabilization techniques are employed to finish and converge coefficients in a timely manner without exhausting degrees of freedom.

The example forecast comparator 112 inspects the sales forecasts to verify that they meet a threshold degree of integrity (block 208). Those forecasts that fail to meet the threshold degree of integrity, such as a failure to employ statistically significant standards and/or techniques, may be eliminated from further consideration. As described above, generalized and/or specific business rules may be employed to cull one or more forecasts (sales and/or driver forecasts) that exhibit results and/or output deemed “wild” and/or otherwise outside boundaries of expectation. In the event a forecast exhibits a fluctuation above or below a threshold value (e.g., a percentage change threshold value), then that corresponding forecast may be selected as a candidate for removal from further consideration.

The example forecast comparator 112 also identifies whether the remaining sales forecasts have any similarity to previously used sales forecasts stored in the example previous forecasts database 114 (block 210). If so, then the example forecast comparator 112 compares the similar forecasts and imputes an indication of success or failure to the similar new sales forecasts (block 212). In the event one or more similarities exit between a previously used forecast and one or more of the sales forecasts received from the example new forecasts database 102, a corresponding indication of success or failure is imputed (e.g., imputed in the form of a mathematical weight) to the new sales forecast. For example, in the event one of the new sales forecasts is similar to one of the previously used forecasts, and prior use of the previously used sales forecast illustrates that it performed relatively well, then the new sales forecast is maintained as a candidate to be used in a current sales forecast attempt. On the other hand, in the event one of the new sales forecasts is similar to one of the previously used forecasts, and prior use of the previously used sales forecast illustrates that it performed relatively poorly, then the new sales forecast is eliminated as a candidate to be used in a current sales forecast attempt. Relatively poor performing and/or relatively good performing previously used sales forecasts may be determined based on after-the-fact comparisons of forecast data to subsequent in-market performance data. A candidate new sales forecast having a relatively highest indication of success may be selected as the vetted sales forecast (block 214).

As described above, the vetted sales forecast is provided to the example alerting engine 118 for alert construction (block 216), to the example driver identifier 116 for driver identification (block 218), to the example decomposition engine 120 for volume decomposition (block 220), and to the example GUI engine 122 for UI construction (block 222). While example driver identification (block 218) will be discussed first, the order in which the example driver identification (block 218) or an example alert construction (block 216) may be performed in any order, including parallel execution.

FIG. 3 is a schematic illustration of the example driver identifier 116 of FIG. 1. In the illustrated example of FIG. 3, the driver identifier 116 includes a historical threshold eliminator 302, a Euclidian distance engine 304, a zone identifier 306, a cluster analyzer 308, a coefficient integrator 310 and a driver forecast selector 312. In operation, the example historical threshold eliminator 302 eliminates driver forecasts that fall below one or more lower thresholds. The one or more lower thresholds may be indicative of relatively extreme driver forecast behaviors that do not have corresponding historical support from empirical observation. In some examples, the historical threshold eliminator 302 removes one or more forecasts that are considered “wild” and otherwise implausible. Implausible forecasts may be determined by, for example, business judgment, such as when sales are not likely to increase by 30% in a year if the share of brand is greater than 40%. In other examples, an implausible forecast may be identified by one or more natural thresholds being exceeded, such as distributing products to more than 100% of stores. Similarly, the example historical threshold eliminator 302 eliminates driver forecasts that exceed one or more upper thresholds. The one or more upper thresholds may be indicative of relatively extreme driver forecast behaviors that overestimate driver influence on a market performance and fails to have historical support from empirical observation.

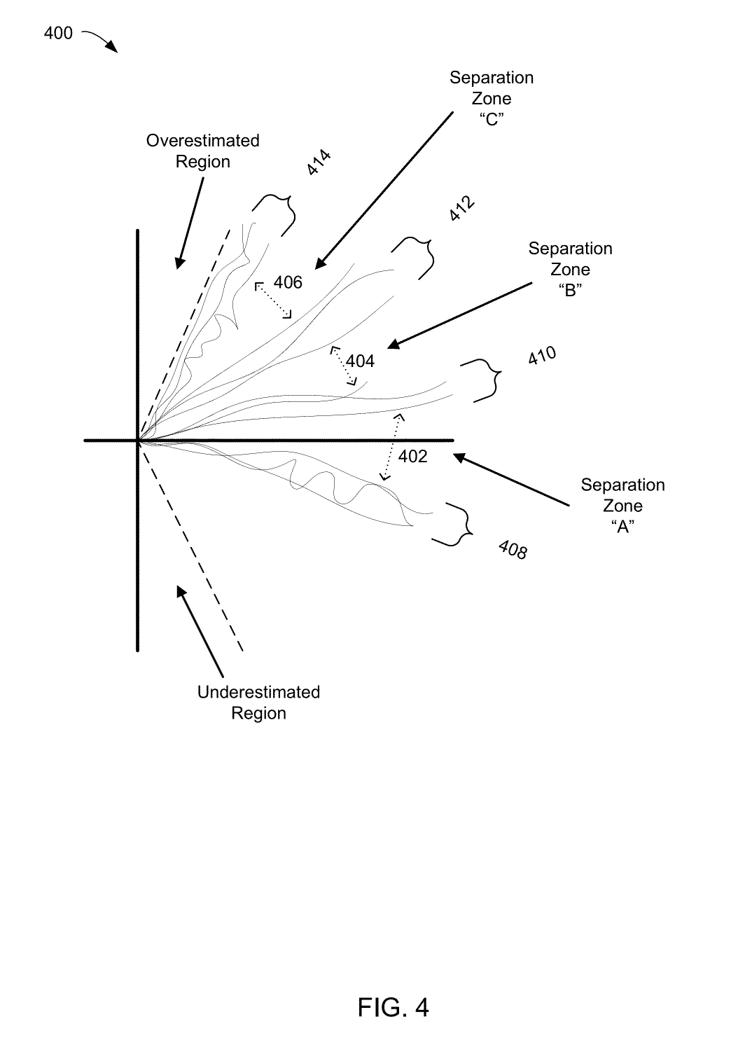

With the extreme overestimated driver forecasts and extreme underestimated driver forecasts eliminated from further consideration, the example Euclidian distance engine 304 calculates relative distances between the remaining driver forecasts. Depending on the number and type of driver forecasts under consideration, the example zone identifier 306 identifies one or more separation zones having the greatest relative distance value(s). The example cluster analyzer 308 generates one or more driver forecast clusters that are separated by the one or more separation zones identified by the example zone identifier 306. Briefly turning to FIG. 4, an example driver forecast aggregation graph 400 includes any number of driver forecasts (shown as solid line traces). In the illustrated example of FIG. 4, the plurality of driver forecasts may be associated with a particular driver type, such as price, trade promotion, distribution, etc. Any number of separate driver forecast aggregation graphs may be generated by the example Euclidian distance engine 304 to identify zones and/or clusters associated with each driver type.

As described above, the example Euclidian distance engine 304 calculates distance values between each driver forecast, and the example zone identifier 306 identifies those distances having the greatest relative value(s). Generally speaking, the example zone identifier 306 employs the Euclidian distances to group similarly trending forecasts. As such, each zone may be represented as a mathematically identifiable separation between groups of similarly trending driver forecasts, which cluster similar forecasts together in a group. In the illustrated example of FIG. 4, the zone identifier 306 identified a first separation zone “A,” a second separation zone “B,” and a third separation zone “C.” For example, the first separation zone “A” was identified by the zone identifier 306 because a first Euclidian distance 402 was deemed to have a relatively greater value than distances between one or more other individual driver forecasts. Similarly, the second and third separation zones “B” and “C” were identified because they exhibit relatively greater distance values (404, 406) when compared to the individual driver forecasts of the aggregation graph 400. The example cluster analyzer 308 identifies driver forecast groupings that are separated by each of the identified separation zones (e.g., zone “A,” “B,” and “C”) to generate a first cluster 408, a second cluster 410, a third cluster 412 and a fourth cluster 414.

Each of the generated and/or otherwise identified clusters (408, 410, 412, 414) are compared against example criteria to narrow a selection of a finite number of driver forecasts with which to employ with the vetted sales forecast. For example, each cluster may be compared to a potential magnitude of sales capability, or a historical likelihood based on similarly observed driver effects. For each driver type, the leading clusters are selected and a single driver forecast from each cluster is selected as a surrogate driver forecast for that cluster. Generally speaking, while each cluster may have any number of individual driver forecasts therein, each cluster illustrates a general predictive similarity and/or trend. Some of the individual driver forecasts within a cluster may exhibit seasonal fluctuations, and others may exhibit a lower degree of localized fluctuation. However, in the aggregate, each of the clusters exhibit a similar general trend of predictive performance. Selecting one of the many driver forecasts within each cluster of interest serves as a surrogate for the whole cluster, thereby reducing (e.g., minimizing) the number of driver forecasts from which to choose. Additionally, reducing the number of driver forecasts in this manner facilitates a corresponding computational reduction.

Returning to FIG. 3, the example coefficient integrator 310 combines the accumulated and/or otherwise selected surrogate driver forecasts of one or more driver types (e.g., price, promotion, distribution, etc.) with the stabilized coefficients from the example coefficients database 110 and identifies a corresponding error for each selected permutation of driver forecasts. As described above, each of the remaining driver forecasts represent a statistical approach to an opinion of possible future values of each driver type. To determine the best driver forecasts to best describe the vetted forecast sales pattern, the example coefficient integrator 310 cycles through all permutations of selected driver forecasts to reduce the ultimate number of driver forecasts to evaluate. The example coefficient integrator 310 matches and merges coefficients to their respective driver counterparts to facilitate one or more regression equations established during a coefficient stabilization. In other words, the best driver forecasts (e.g., candidate forecasts) may be based on the combination of driver forecasts that best predict the vetted sales forecast by minimizing an example regression process and/or equation, such as example Equation 1 below.

Sales=β₀+β₁*x₁+β₂*x₂+ . . . +βₙ*xₙ+ε Equation 1.

In the illustrated example of Equation 1, Sales represents the vetted sales forecast, β represents stabilized coefficients from the example coefficient database 110, and values of x represent different driver type permutations. Depending on the available processing capabilities, a finite number of driver type permutations may be selected for example Equation 1 to identify the combination of driver types that minimize the corresponding error. The example driver forecast selector 312 chooses those combinations of driver forecasts having the lowest error and, thus, best describe the vetted sales forecast.

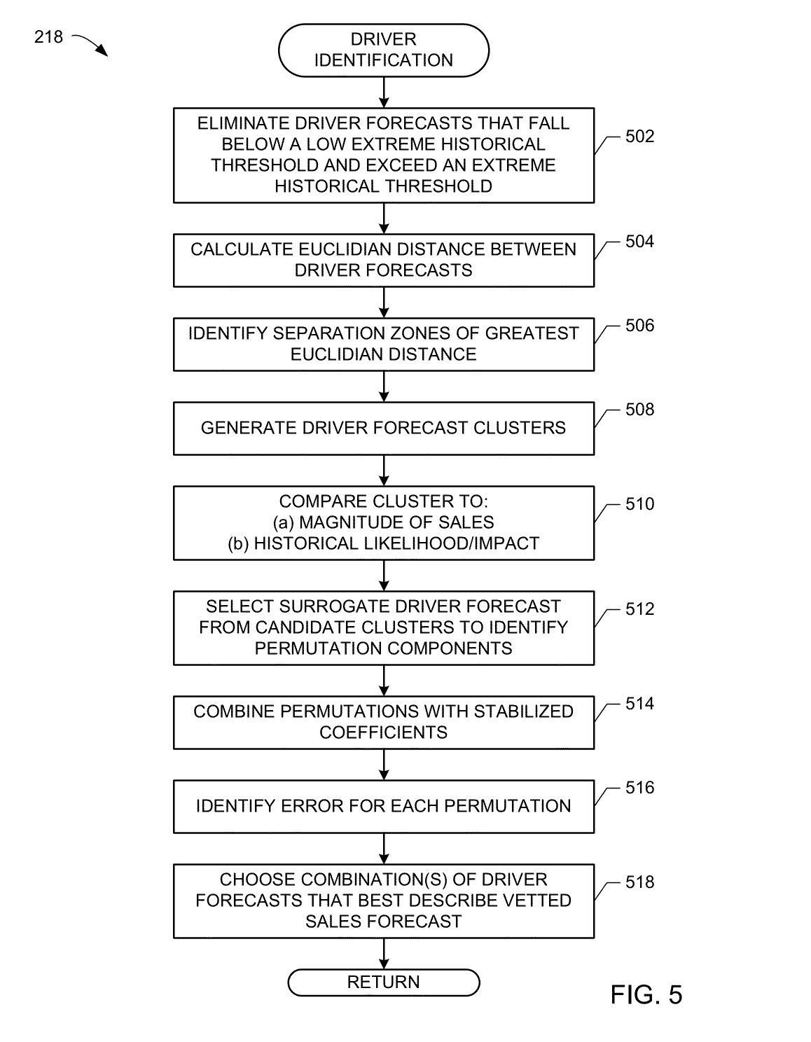

The program 218 of FIG. 5 begins at block 502 where the example historical threshold eliminator 302 eliminates driver forecasts that fall below a low extreme historical threshold and/or exceed a high extreme historical threshold, or exceed high extreme natural boundaries, such as ensuring that price is non-zero and positive. As described above, available driver forecasts may be numerous and computationally burdensome for complete consideration. On the other hand, the available market data, such as market data from the example market data database 104, may be relatively sparse (e.g., thirty-six months worth of data). Generally speaking, valid statistical regression analysis requires approximately ten observations per available driver and, with a disproportionate number of available driver forecasts, the number of observations to explain each driver becomes too low to provide significant and/or reliable results. Thus, reducing the number of available driver forecasts allows further analysis to proceed with less computational burden and greater statistical significance.

The example Euclidian distance engine 304 calculates distance values between each of the available driver forecasts for each type of driver forecast (block 504). As shown in the example driver forecast aggregation graph 400 of FIG. 4, any number of graphs may be generated based on the type(s) of candidate driver(s) of interest. Based on the distance values calculated by the example Euclidian distance engine 304, the example zone identifier 306 identifies separation zones having the greatest relative distance values (block 506). For example, the zone identifier 306 may generate a ranked list of all relative driver forecast distances. Additionally, the example zone identifier may generate the ranked list that contains relative distances for only adjacent driver forecasts. The example cluster analyzer 308 generates one or more driver forecast clusters delineated by the zones having the greatest relative separation values (block 508) and compares each cluster to one or more criteria indicative of statistical reliability (block 510). As described above, the example cluster analyzer 308 may compare the identified clusters to information related to a historical likelihood, a historical impact and/or a potential magnitude of sales effect. The remaining clusters are further examined by the example cluster analyzer 308 to select a surrogate driver forecast representative of its respective cluster (block 512). For each driver type, the example cluster analyzer 308 selects a finite number of surrogate driver forecasts to limit a number of driver forecast permutations to be used in one or more regression analysis operations. For example, the cluster analyzer 308 may select a numerically middle or centered driver forecast from each identified cluster, a spatially middle driver based on a spatial distance between two separation zones, or a driver forecast having a relatively lowest localized fluctuation.

The driver forecast permutations are combined with the stabilized coefficients from the example coefficients database 110 (block 514) and applied to one or more regression equations, such as the example Equation 1, to identify an error value for each driver forecast permutation (block 516). Those driver forecast permutations having the lowest error are ranked and/or otherwise identified and selected by the example driver forecast selector 312 to be used when further analysis of the vetted sales forecast (block 518).

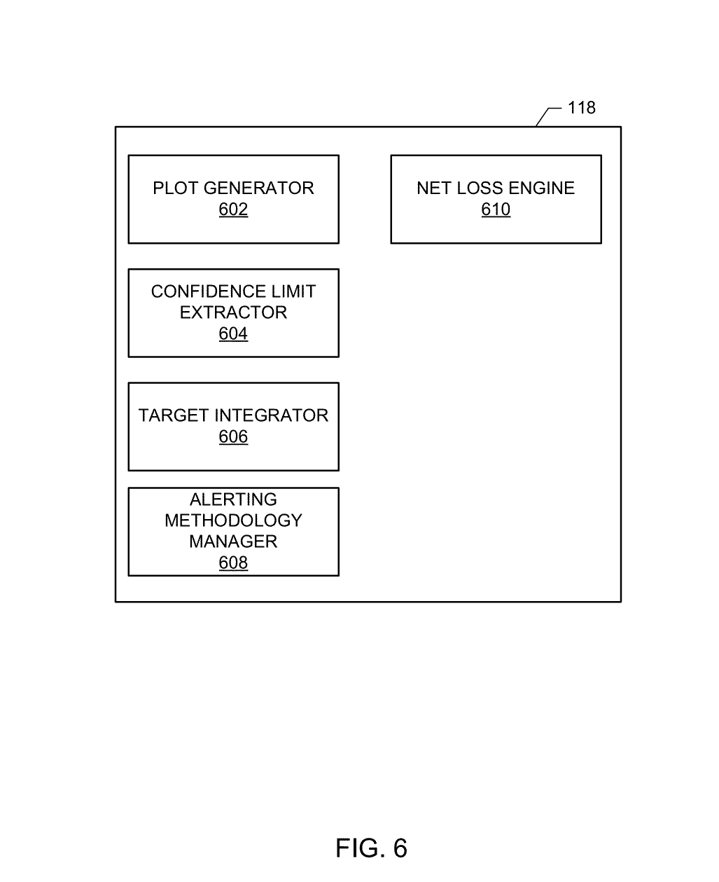

FIG. 6 is a schematic illustration of the example alerting engine 118 of FIG. 1. In the illustrated example of FIG. 6, the alerting engine 118 includes a plot generator 602, a confidence limit extractor 604, a target integrator 606, an alerting methodology manager 608, and a net-loss engine 610. In operation, the example plot generator 602 retrieves and/or otherwise receives the vetted sales forecast from the example forecast comparator 112 and generates a plot of both past sales performance and forecasted performance. Additionally, because confidence limits are built into the model associated with the vetted sales forecast, the example confidence limit extractor 604 extracts data associated with the confidence limits and overlays it on the plot.

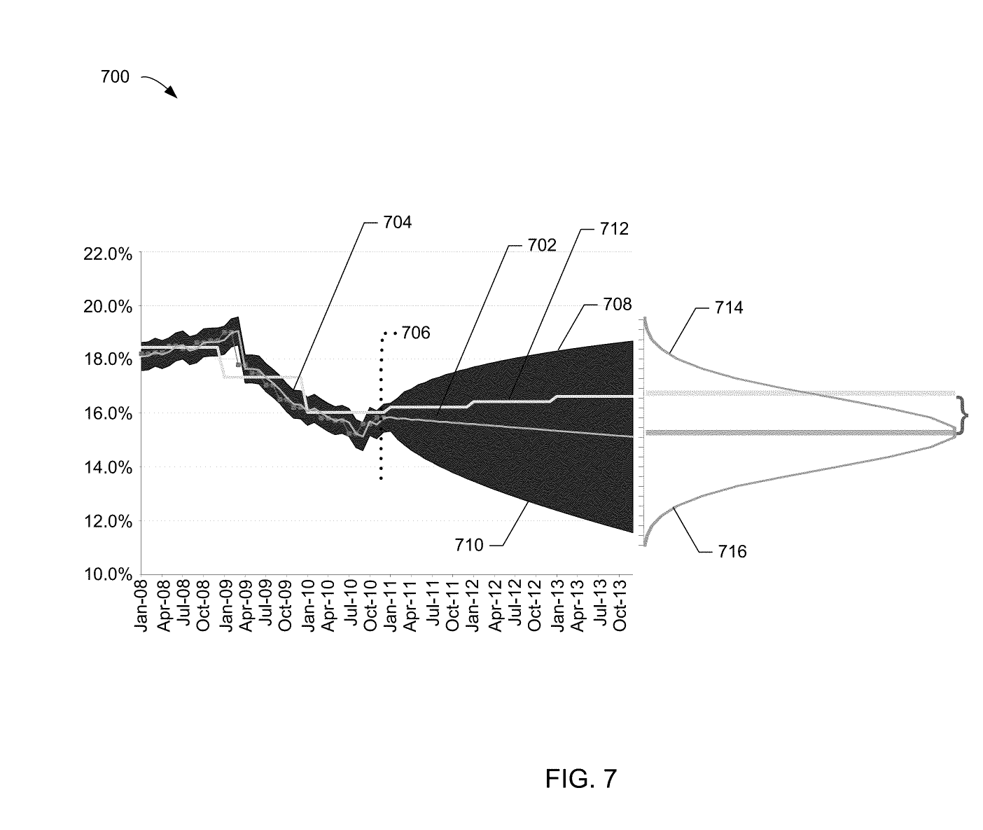

For example, FIG. 7 illustrates an example forecast plot 700 that includes the vetted sales forecast 702 and past performance 704, each of which are separated by a current date line 706. In other words, data to the left of the current date line 706 represents actual market activity, while data to the right of the current date line 706 represents forecasted market activity. The data associated with the past performance 704 may be obtained from empirically observed sales numbers, while the vetted sales forecast 702 represents an indication of expected performance. Additionally, the example forecast plot 700 includes an upper confidence limit 708 and a lower confidence limit 710 indicative of a degree of how accurately the vetted sales forecast is expected to perform. The example forecast plot 700 also includes a plot of the market researcher (e.g., analyst) plan for the product of interest 712, which is generated by the example target integrator 606. A distribution of likely performance for the plan 714 and for the vetted sales forecast 716 may also be calculated by the example target integrator 606 and one or more corresponding plots generated by the example plot generator 602. While the example distributions 714, 716 have a bell curve shape, any other type of forecast distribution shape may be used.

The market researcher may employ the vetted forecast for any future duration in an effort to appreciate how well or poorly product performance will match the plan (e.g., the plan 714 of FIG. 7). For forecasting efforts having a relatively short duration (e.g., one to three months into the future), the example alerting methodology manager 608 may select a first alerting methodology. Generally speaking, an alerting methodology may be invoked and/or otherwise selected based on its ability to suppress, avoid, reduce and/or minimize error. Further, the ability to suppress, avoid, reduce and/or minimize error may be based on a particular duration for which the vetted sales estimate predicts. On the other hand, for forecasting efforts having a relatively greater duration (e.g., greater than 3 months, 12 months, etc.), the example alerting methodology manager 608 may select a greater number of alerting methodologies in an effort to reduce (e.g., minimize) the effects of predictive error. For example, a probability value assessment alerting methodology may not exhibit statistically significant error values when employed with forecasting attempts less than three months in the future. However, while aspects of the probability value assessment methodology maintain value for forecasting durations greater than three months in the future, such methodologies may also exhibit a greater degree of bias and/or error. To reduce (e.g., minimize) such bias and/or error, the example alerting methodology manager 608 may employ and/or otherwise combine a greater number of alerting methodologies when the forecasting duration is greater than a threshold amount of time. For example, for forecasting durations greater than twelve months in the future, the example alerting methodology manager 608 may employ the probability value assessment methodology, the logit assessment methodology and/or a net-loss methodology via the example net-loss engine 610. Depending on the forecasting duration, a likelihood of missing a sales target associated with each type of alerting methodology, and/or the type(s) of alerting methodologies selected, the example alerting methodology manager may apply alerting methodology weights and/or issue one or more alerts.

The example confidence limits built-into the vetted sales forecast may not align with business practices and/or a comfort zone of the market researcher. Some market researchers (and/or clients of the market researchers) are relatively reluctant to making product marketing strategy changes because, for example, corporate budget limits do not accommodate for extra spending and/or the market researcher is generally against spending additional money and/or resources beyond already established plans. In other examples, some market researchers are relatively sensitive to market share loss and/or any potential of market share loss. As such, relatively sensitive market researchers may wish to enact one or more product marketing strategy adjustments in view of any indication that market share might be at risk. Generally speaking each type of market researcher (e.g., analyst, retail manager, product manufacturer, etc.) may have a certain probability of aversion to spending money when it was not necessary to do so, and a certain probability of aversion of not spending money when it was prudent to do so to avoid market share loss. In the event the confidence limits are set too wide (e.g., relatively insensitive) when compared to historical responses of market activities, then any alerts generated when the confidence limit boundaries are crossed may occur too late in view of the expectations and/or preferences of the relatively sensitive market researcher. On the other hand, in the event the confidence limits are set too narrowly (e.g., a relatively greater degree of sensitivity) when compared to historical responses of market activities, then alerts will occur on a relatively more frequent basis. Frequent alerts may be deemed annoying to market researchers that are relatively tolerant of some market share loss and/or seasonal fluctuation with respect to market share.

The confidence limits of a vetted sales forecast model may be compared to one or more performance goals (e.g., plan, target, etc.), as described in further detail below. A first alerting methodology may yield a first likelihood of missing the target, while a second alerting methodology may yield a second likelihood of missing the target. For example, the first alerting methodology may employ a probability analysis related to composit leading indicators (CLI) to calculate a likelihood (a first likelihood) of missing the sales target. In other examples, the second alerting methodology may employ a logit model to predict and/or otherwise calculate a likelihood (e.g., a second likelihood) of missing the target, in which marketing drivers are incorporated as regressors.

Each likelihood of missing the target may be compared with a threshold, such as a threshold that comports with expectations of the market researcher. Some alerting methodologies may not result in triggering the threshold based on a duration for which the vetted sales forecast is used, such as, for example, a relatively short predictive duration (e.g., a first future date). On the other hand, some alerting methodologies may trigger the threshold indicative of missing the target, during such relatively short predictive duration(s). Because a first alerting methodology may not trigger the threshold when a second alerting methodology does trigger the threshold, then a first alert may be generated by the example alerting methodology manager 608. In the event that both the first and second alerting methodologies trigger the threshold when the example vetted sales forecast is employed for a relatively longer predictive duration (e.g., a second date in the future later than the first future date), then the example alerting methodology manger 608 may generate a second alert. The example second alert may be deemed urgent, particularly when more than one alerting methodology provides an indication of a likelihood of missing the sales target.

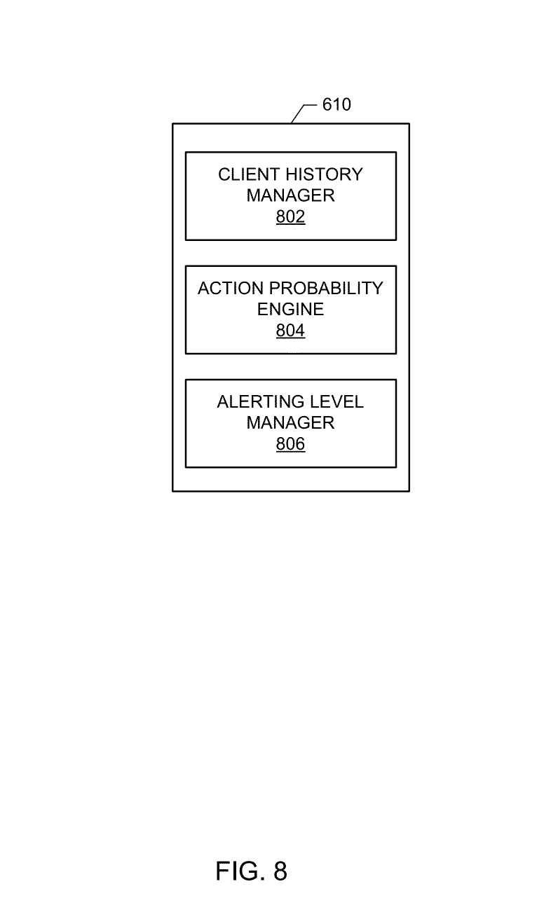

FIG. 8 is a schematic illustration of the example net-loss engine 610 of FIG. 6. In the illustrated example of FIG. 8, the net-loss engine 610 includes a client history manager 802, an action probability engine 804 and an alerting level manager 806. In operation, the example client history manager 802 retrieves historical driver control data associated with the market researcher (e.g., a client and/or researcher chartered with management of marketing for a product of interest). For example, the client history manager 802 identifies performance changes (e.g., changes in sales) that have occurred in the past, and identifies corresponding client adjustments that were invoked in response to such performance changes. Generally speaking, the client has finite control over some driver types, such as price, promotion and/or distribution. By monitoring the historical responses a client has taken to sales performance changes, a baseline may be generated that aligns with client expectations when future performance changes are detected and/or otherwise expected to occur. As such, an advanced alert of one or more performance changes may occur within a period of time with which the client is accustomed to receiving and/or within a comfort zone of the client.

The example action probability engine 804 calculates a probability of not taking action when action was actually needed to avoid a loss of market share and/or a loss in sales, referred to herein as a “false negative.” In other words, the false negative relates to the cost associated with not spending money on marketing strategy adjustment efforts, when doing so would result in saving and/or otherwise improving sales. A false negative occurs when there is a difference between a plan (e.g., a marketing target) and a forecast, but the researcher is not notified of the difference because of the manner in which alerting levels (e.g., thresholds) are set. Additionally, the example action probability engine 804 calculates a probability of taking action when action was not needed, referred to herein as a “false positive.” In other words, the probability of wasting money on marketing strategy efforts to boost sales performance when the need to do so was not necessary. A false positive occurs when there is not a difference between a plan (e.g., a marketing target) and a forecast, the researcher is nevertheless prompted to it because of the manner in which alerting levels (e.g., thresholds) are set.

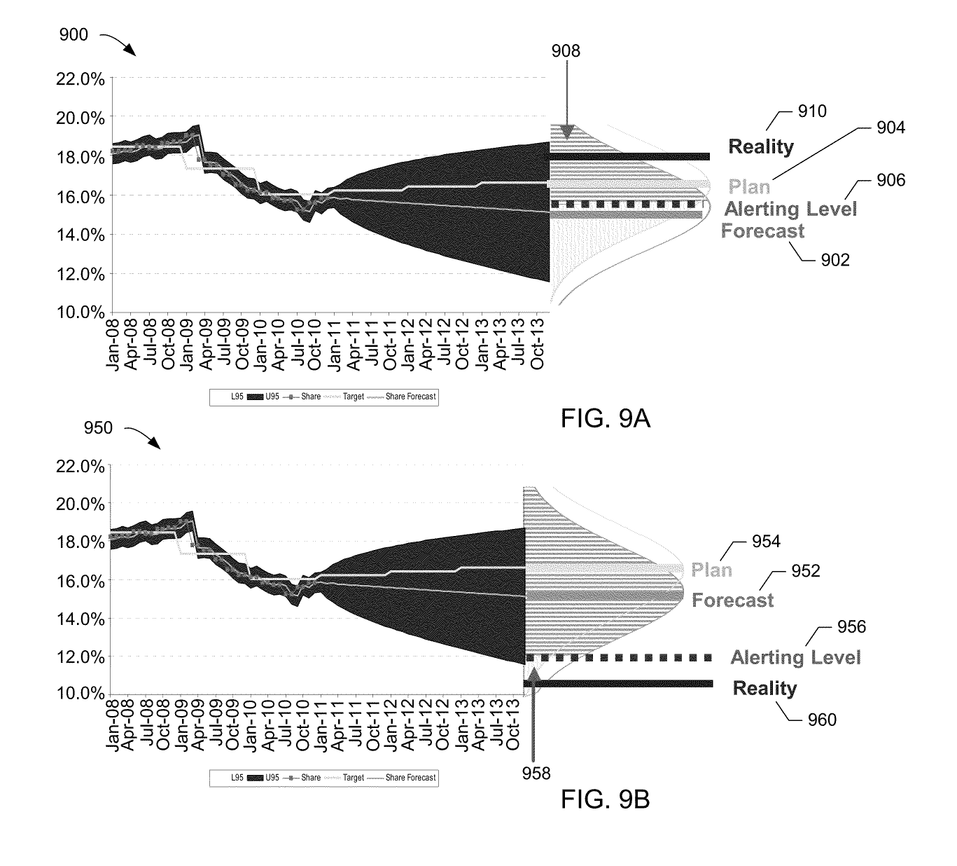

In the illustrated example of FIG. 9A, an example forecast plot 900 includes a forecast 902 and a plan 904. Additionally, the example forecast plot 900 includes an alerting level 906 that may be set in a manner that determines a probability of not taking action when it should have been taken to avoid a loss 908 (i.e., the shaded area above the alerting level 906). Also in the illustrated example of FIG. 9A, the forecast plot 900 includes a reality indicator 910 that shows market performance occurred in a manner better than the forecast 902 (e.g., based on after-the-fact market data analysis). In such a hypothetical in which the reality indicator 910 outperforms the forecast 902, action was taken (i.e., because the forecast 902 fell below the alerting level 906), but such action was ultimately not necessary. Prior to knowledge of where the reality indicator 910 will occur (e.g., based on after-the-fact market data analysis), a market researcher would have recommended the action (e.g., invoke an advertising campaign to capture market share) that was not ultimately needed to meet the plan 904. Each market researcher and/or a client of the market researcher may have an associated sensitivity (e.g., cost) associated with wasting money when it was not necessary to do so.

On the other hand, and as shown in the illustrated example of FIG. 9B, an example forecast plot 950 includes a forecast 952 and a plan 954. Additionally, the example forecast plot 950 includes an alerting level 956 that may be set in a manner that determines a probability of taking action when it was not necessary to do so 958 (i.e., the shaded area below the alerting level 956). The example forecast plot 950 of FIG. 9B also includes a reality indicator 960 that shows market performance occurred in a manner worse than the forecast 952 (e.g., based on after-the-fact market data analysis). In such a hypothetical in which the reality indicator 960 underperforms the forecast 952, action was not taken (i.e., because the forecast 952 was above the alerting level 956), but action should have been taken.

Each of these types of actions includes an associated pain threshold for the client that may be reduced (e.g., minimized). For example, a function associated with (a) a value associated with a cost for not taking action when it is necessary to avoid sales loss and (b) a value associated with a cost for taking action when it is not needed to maintain target sales may be minimized to reduce (e.g., minimize) a net expected loss. Example Equation 2 may be reduced (e.g., minimized) in view of client sensitivities.

NL=Prob(NA)*Cost_{NA}Prob(A)*Cost_{A} Equation 2.

In the illustrated example of Equation 2, NL represents the net expected loss, Prob(NA) represents the probability of not taking action when it should have been taken to avoid a loss of market share (e.g., loss of sales revenue, etc.), and Prob(A) represents the probability of taking action when it was not needed to maintain market share. Additionally, Cost_{NA} represents the cost of lost revenue or margin by not taking action, and Cost_{A} represents the cost of marketing expenses less incremental profit by taking action when it was not necessary to do so.

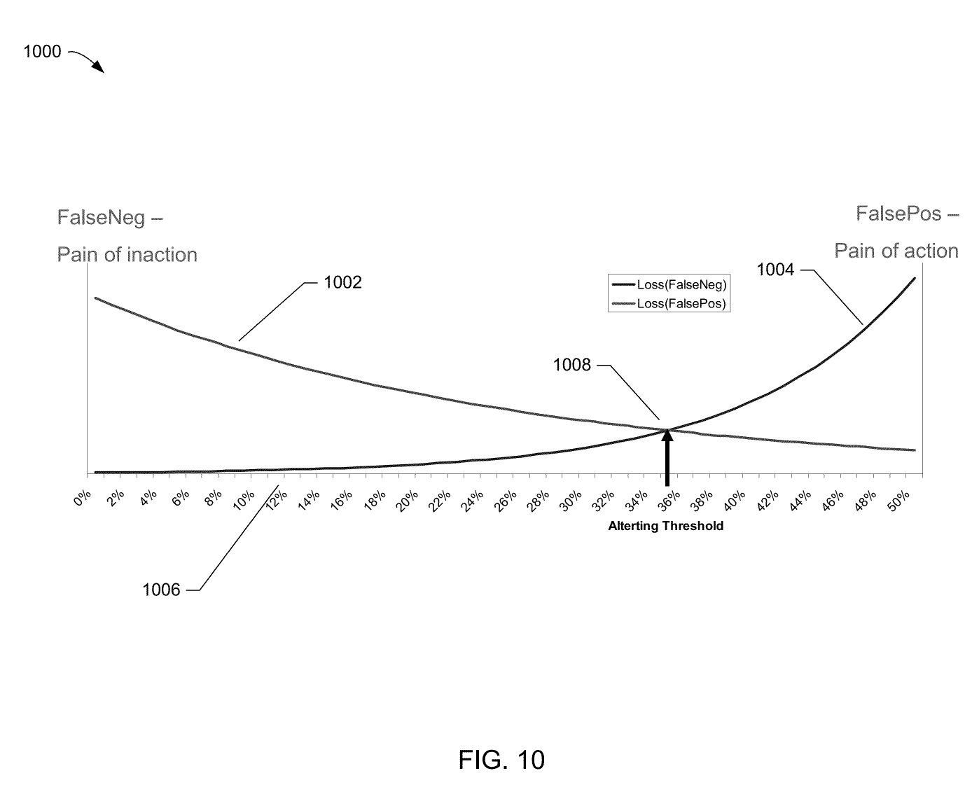

In the illustrated example of FIG. 10, a plot 1000 is shown having a curve associated with a pain of inaction (false negative) 1002, a pain of action (false positive) 1004, and corresponding alerting thresholds 1006. Example equation 2 can be minimized, in which costs to the likelihood of outcomes may result in an alerting threshold that balances the pain of inaction 1002 and the pain of action 1004, to identify an alerting threshold candidate value 1008, as shown in FIG. 10.

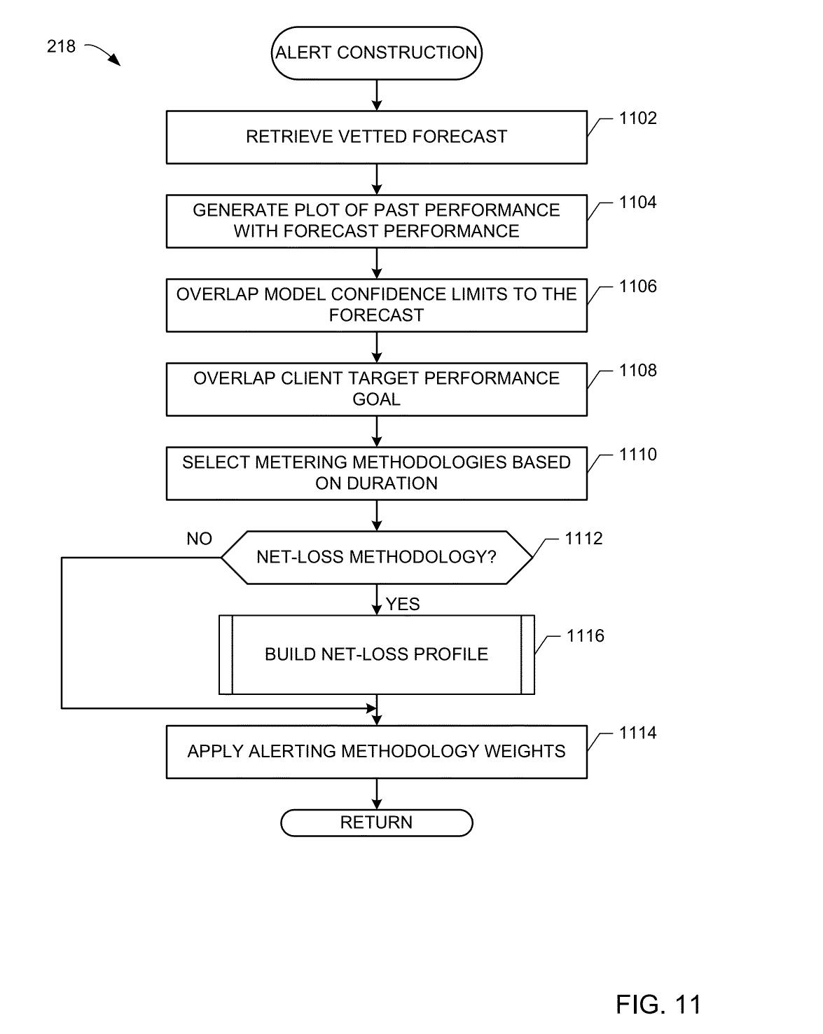

The program 216 of FIG. 11 begins at block 1102 where the example plot generator 602 retrieves and/or otherwise receives the vetted sales forecast from the example forecast comparator 112 to generate a plot, such as the example forecast plot 700 of FIG. 7. A plot of past performance and forecast performance is generated by the example plot generator 602 based on the vetted forecast and market data retrieved from the example market data source 104 (block 1104). As discussed above in connection with FIG. 7, data to the left of the current date line 706 represents actual market activity, while data to the right of the current date line 706 represents forecasted market activity and one or more plans. Each vetted sales forecast is a model that includes confidence limits, which are extracted by the example confidence limit extractor 604 and added to the example plot (block 1106). For example, the example upper confidence limit 708 and lower confidence limit 710 of FIG. 7 reflect an uncertainty range of the vetted sales forecast. While the example uncertainty appears in FIG. 7 as a bell-shaped curve, any other shape may be included based on the selected vetted sales forecast.

The example target integrator 606 overlaps one or more target performance goals (e.g., plan) on the example plot 700 (block 1108), which illustrates one or more circumstances where a marketing plan may deviate from a forecast. Briefly returning to the illustrated example of FIG. 7, the distribution of performance for the plan 714 indicates a degree of deviation from the vetted sales forecast 716. As described above, some clients, analysts, product manufacturers and/or market researchers have particular sensitivities regarding a degree of deviation of the sales forecast 716 and the plan 714. Based on such sensitivities, the example confidence limits (e.g., 708, 710) and/or other alerting thresholds may be established in a manner that is consistent with client preferences. Based on the duration of the vetted sales forecast, the example alerting methodology manager 608 selects one or more alerting methodologies to employ with the forecast (block 1110). As described above, alerting methodologies may each exhibit particular strengths and/or weaknesses. Alerting methodologies may include, but are not limited to a net-loss alerting methodology that considers historical driver behaviors in response to changing market conditions, logit alerting methodologies and/or probabilistic alerting methodologies.

In the event that the net-loss methodology is not selected by the example alerting methodology manager 608 (block 1112), then the alerting methodology manager 608 selects one or more alerting methodologies based on the sales forecast duration and corresponding weights for each methodology (block 1114). For example, methodologies that exhibit relatively accurate performance during a relatively short timeline may be weighted higher when analyzing more recent alerting points of the forecast. In the event that the net-loss methodology is selected (block 1112), then the example net-loss engine 610 is invoked (block 1116).

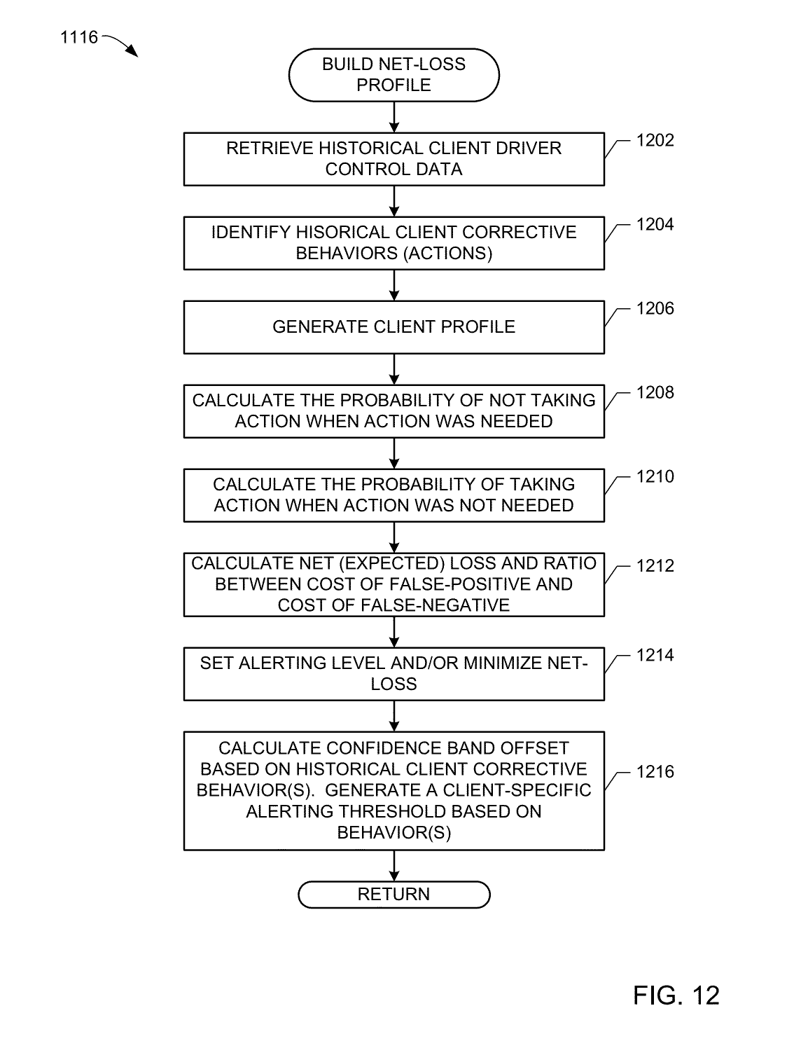

The program 1116 of FIG. 12 begins at block 1202 where the example client history manager 802 receives and/or otherwise retrieves historical client driver control data. For example, the client history manager 802 may parse prior market data (e.g., from the example market data source 104) for one or more indications of analyst control over one or more drivers to establish a historical dataset of client behavior. As described above, drivers over which a client may have exercised control include, but are not limited to price, promotion, distribution, etc. In some examples, the client history manager distinguishes between drivers that have been historically controlled and/or otherwise manipulated by the client from changes to drivers that are outside client control. In other examples, the client history manager 802 excludes non-client and/or researcher controlled triggers. Additionally, the example client history manager 802 identifies historical client corrective behaviors in response to one or more market triggers (block 1204). A market trigger may temporally occur prior to one or more corresponding indications of client corrective behavior(s) and may include, but are not limited to competitive promotions, competitive TPRs, percent sales decrease, percent share decrease, etc. In some examples, one or more triggers may occur after one or more observed instances of client driver control, such as a commodity price increase adjustment prior to an anticipated demand increase (e.g., a fuel price increase prior to spring break). The example client history manager 802 generates a client profile based on the collected triggers and one or more corresponding instances of driver control/adjustment (block 1206).

Based on the client profile, the example action probability engine 804 calculates a probability of not taking action when action is needed to meet a marketing objective and/or to prevent missing the marketing objective (see Prob(NA) of example Equation 2) (block 1208). As described above, the probability of not taking action (e.g., preventing a TPR, preventing an advertising campaign, etc.) may be multiplied by a cost of lost share, lost margin and/or lost revenue to calculate a corresponding indication of pain associated with inactivity. Additionally, based on the client profile, the example action probability engine 804 calculates a probability of taking action (e.g., initiating a TPR, initiating an advertising campaign, etc.) when action was superfluous to meeting the marketing objective and/or otherwise not needed to accomplish the marketing objective (see Prob(A) of example Equation 2) (block 1210). As described above, the probability of taking action when it was not needed may be multiplied by a cost of wasted money to calculate a corresponding indication of pain associated with superfluous market activity when a plan was on target. The net-expected loss may be calculated by the example action probability engine 804 in a manner consistent with example Equation 2 (block 1212). Additionally, the example action probability engine 804 may calculate a ratio between the cost of false positives to the cost of false negatives in view of the client profile to ascertain a client propensity or willingness to spend any amount of money to avoid a decline of a market metric (block 1212). For example, a higher number associated with a false negative cost indicates a propensity of the client to spend greater amounts of money to avoid a share decline, even when it might not be necessary to do so.

The example alerting level manager 806 sets the alerting level in a manner that reduces (e.g., minimizes) the net loss (block 1214). As described above, example Equation 2 may be minimized to find an alerting level that is acceptable to the client as determined by prior client behaviors represented in the profile. Additionally, an expected cost of a false negative may be determined in a manner consistent with example Equation 3, and an expected cost of a false positive may be determined in a manner consistent with example Equation 4.

ExpectedCost_{fn}=∫_{-∞}^{Plan}Cost(z)*(∫_{AlertLevel}^{-∞}[(Y(x)_{u=z}])dx)dz Equation 3.

ExpectedCost_{fp}=Cost_{fp}*∫_{+∞}^{AlertLevel}(Y(x)ᵤ₌ₚₗₐₙ)dx Equation 4.

Based on the profile, the reduction (e.g., minimization) of the net loss and calculation of the expected cost of a false positive and a false negative, the example alerting level manager 806 calculates confidence band offsets in a manner consistent with client expectations (block 1216). The client tailored confidence bands allow, in part, one or more alerts to be generated for the client so that corrective action may be taken, if at all, that reduces a pain of overestimation and underestimation. One or more user interfaces may be tailored and/or generated for the client by the example GUI engine 122, as described in further detail below.

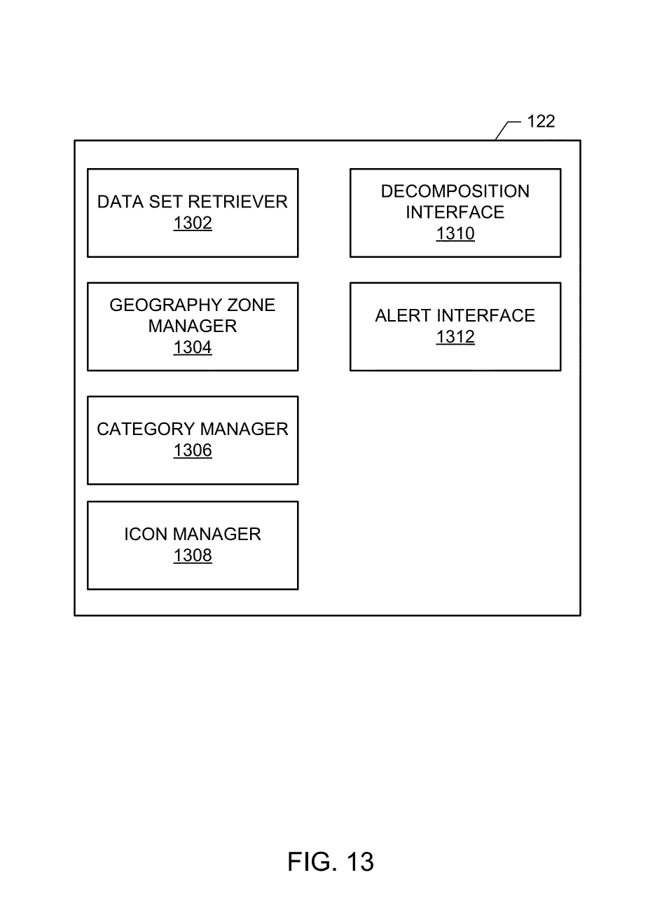

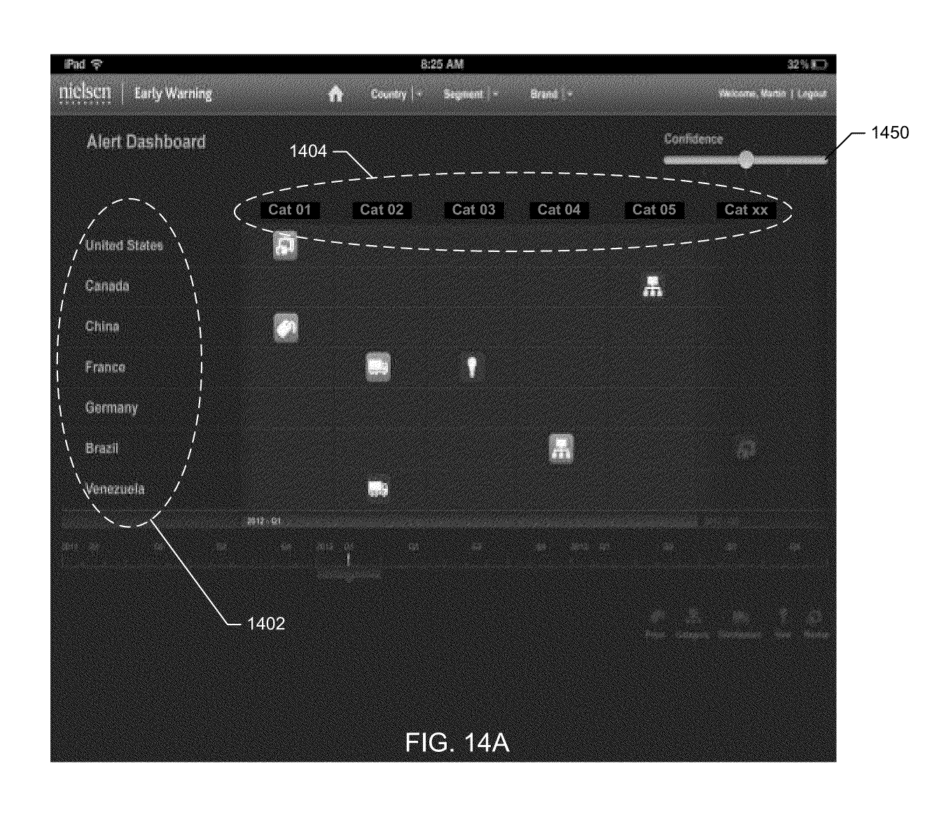

FIG. 13 is a schematic illustration of the example GUI engine 122 of FIG. 1. In the illustrated example of FIG. 13, the GUI engine 122 includes a data set retriever 1302, a geography zone manager 1304, a category manager 1306, an icon manager 1308, a decomposition interface 1310 and an alert interface 1312. In operation, the example data set retriever 1302 retrieves and/or otherwise receives alert data from the example alerting engine 118, a vetted sales forecast from the example forecast comparator 112, final driver forecasts from the example driver identifier 116 and decomposition data from the example decomposition engine 120. The example geography zone manager 1304 identifies a geography associated with the vetted sales forecast and associated market data to create a data set that may be selected by a user for graphical review. Within each data set corresponding to a geography (e.g., a United States forecast, a Canadian forecast, an Illinois forecast, a regional forecast, etc.), the example category manager 1306 identifies corresponding category types associated with the selected sales forecast. Category types may include, but are not limited to food products, drug products, skin care products, particular brands within each category, etc. The example icon manager 1308 generates and/or otherwise tailors one or more icons to associate with drivers associated with a geography, a category, a brand and/or a driver.

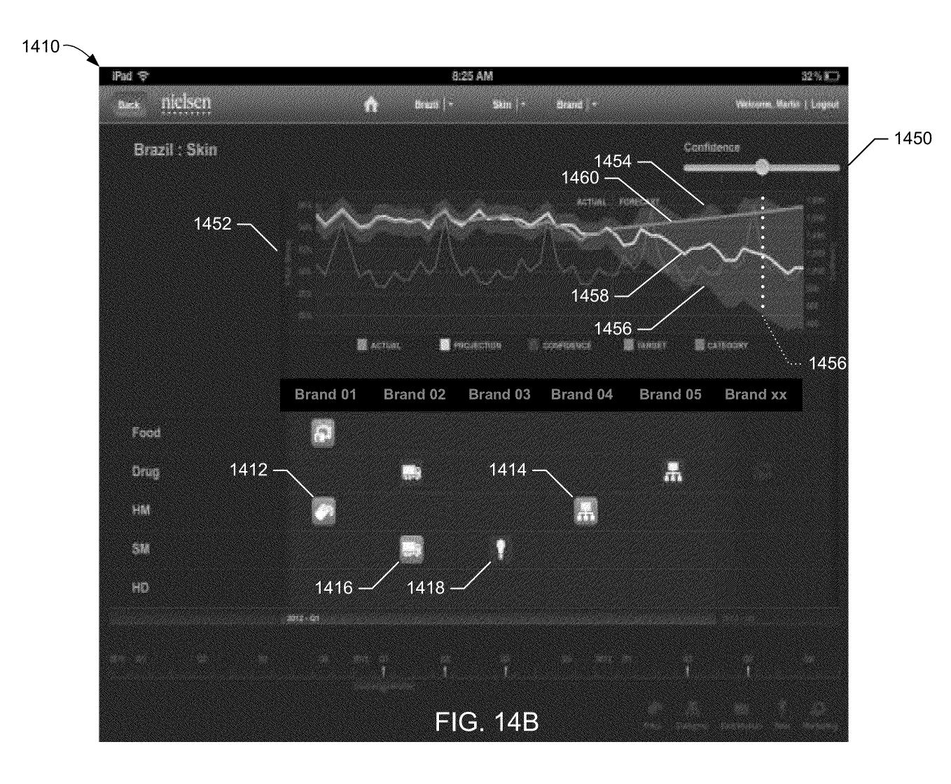

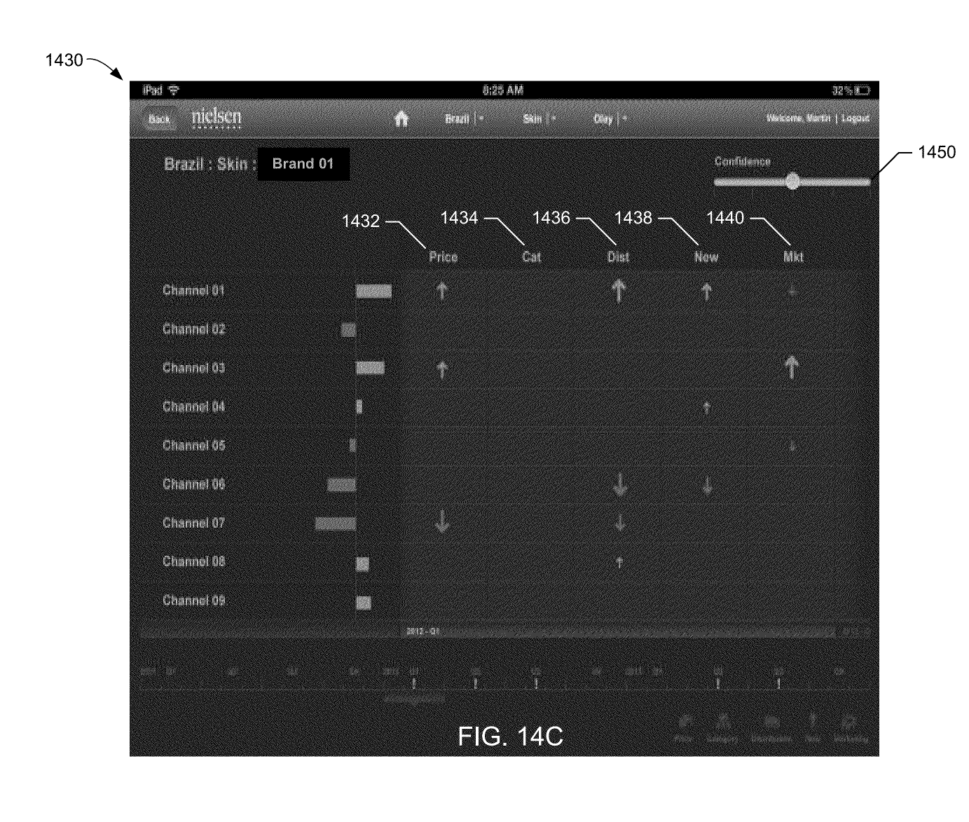

FIG. 14A represents an example GUI 1400 and/or grid of icons generated by the example GUI engine 122 of FIGS. 1 and 13. In the illustrated example of FIG. 14A, the GUI 1400 represents a high level geographic representation of a plurality of data sets associated with a plurality of sales forecasts, in which the GUI 1400 includes one or more geographic regions of interest 1402, one or more categories of interest 1404, and one or more driver icons indicative of causals. Categories may include, but are not limited to, fabric products, pet products, baby products, skin products, hair products, fabric products, food products and/or alcohol products. The example GUI engine 122 aggregates each sales forecast and its associated driver data to allow user selection and exploration of sales forecast details. For example, in the event a user selects one of the geographic regions of interest 1402, then a corresponding set of sales forecasts for the selected region is displayed with a greater degree of granularity.

FIG. 14B represents an example GUI 1410 generated by the example GUI engine 122 in response to a selection to explore sales forecasts associated with Brazil. In the illustrated example of FIG. 14B, the category manager 1306 tailors the GUI 1410 to display available categories having associated sales forecasts. The example icon manager 1308 generates one or more icons and corresponding icon colors to indicate responsible driver types to explain market activity. An example price tag icon 1412 represents a price driver, an example hierarchical tree icon 1414 represents a category driver, an example truck icon 1416 represents a distribution driver, and an example light bulb icon 1418 represents a new products driver. Example icons having a green color indicate the corresponding driver is responsible for a sales estimate meeting or exceeding target expectations, while example icons having a red color indicate the corresponding driver is responsible for a sales estimate falling below target expectations.

FIG. 14C represents an example GUI 1430 generated in response to a user selection of a specific brand, such as “Brand 01”. Specific drivers that affect the “Brand 01” brand are shown as price 1432, category 1434, distribution 1436, new products 1438 and marketing (advertising) 1440. For drivers that cause a bump or improvement in sales, a green up arrow is generated having a corresponding size proportionate to its contributory effect. On the other hand, for drivers that harm the sales target, a red down arrow is generated having a corresponding size proportionate to its negative effect on sales.

Returning to FIG. 14B, an example confidence control 1450 is shown as a slide-control (slider). In the event the confidence control slider 1450 is moved to the left, then the example decomposition interface 1310 invokes the example alerting level manager 806 to reduce a sensitivity of one or more confidence limits. As described above in connection with FIG. 7, an example upper confidence limit 708 and an example lower confidence limit 710 may identify a degree of how accurately the vetted sales forecast is expected to perform. While the vetted sales forecast model includes a corresponding degree of accuracy, such accuracy may not be appropriate for the sensitivities associated with each client and/or market researcher. For example, a first market researcher may have a heightened concern over any possibility of losing market share and, thus, prefer that confidence limits (708, 710) be set as closely as possible to a plan/target (e.g., narrowly set). In such relatively high confidence level settings, moving the slider 1450 to the right (more sensitive) results in relatively minor deviation(s) from the plan and/or forecast to cross the confidence limit boundaries and cause one or more alerts. On the other hand, a second market researcher may be relatively more tolerant of market performance fluctuations, such as seasonal performance fluctuations. For such researchers having a greater degree of tolerance, the example upper confidence limit 708 and lower confidence limit 710 may be set farther apart by moving the example slider 1450 to the left (less sensitive) so that one or more alerts occur less frequently. While the examples above discuss leftward motion as less sensitive and rightward motion as more sensitive, example controls for confidence limits may be established in any orientation and/or manner of control.

In the illustrated example of FIG. 14B, the GUI 1410 includes the confidence control slider 1450 and a corresponding forecast plot 1452. The example forecast plot 1452 includes an upper confidence limit 1454, a lower confidence limit 1456, a vetted sales forecast 1458 and a plan 1460. An initial view of the example GUI 1410 may be generated by the example GUI engine 122 to overlay confidence limit data associated with a corresponding vetted sales forecast, which may reveal confidence limits 1454, 1456 at a default level associated with the vetted sales forecast model, as shown by dotted line 1462. In response to the example confidence control slider 1450 sliding to the right, which may accommodate market researchers having a relatively greater degree of market fluctuation sensitivity, the upper confidence limit 1454 and the lower confidence limit 1456 will converge, thereby reducing the height of the example dotted line 1462. On the other hand, in response to the example confidence control slider 1450 sliding to the left, which may accommodate market researchers having a relatively lower degree of market fluctuation sensitivity, the upper confidence limit 1454 and the lower confidence limit 1456 will diverge, thereby increasing the height of the example dotted line 1462.

While the example confidence control 1450 of FIGS. 14A-C is shown as a slider, any type of control may be used without limitation. In response to one or more changes of the example confidence control, such as the example confidence control slider 1450, corresponding icons (e.g., 1412-1418) and/or arrow magnitudes and/or colors (e.g., see FIG. 14C) will change accordingly.

FIG. 15 is a block diagram of an example processor platform 1500 capable of executing the instructions of FIGS. 2, 5, 11 and 12 to implement the system 100 of FIGS. 1, 3, 6, 8 and 13. The processor platform 1500 can be, for example, a server, a personal computer, an Internet appliance, or any other type of computing device.

The system 1500 of the instant example includes a processor 1012. For example, the processor 1512 can be implemented by one or more microprocessors or controllers from any desired family or manufacturer.

The processor 1512 includes a local memory 1513 (e.g., a cache) and is in communication with a main memory including a volatile memory 1514 and a non-volatile memory 1516 via a bus 1518. The volatile memory 1514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1516 may be implemented by flash memory and/or any other desired type of memory device. Access to the main memory 1514, 1516 is controlled by a memory controller.

The processor platform 1500 also includes an interface circuit 1520. The interface circuit 1520 may be implemented by any type of interface standard, such as an Ethernet interface, a universal serial bus (USB), and/or a PCI express interface.

One or more input devices 1522 are connected to the interface circuit 1520. The input device(s) 1522 permit a user to enter data and commands into the processor 1512. The input device(s) can be implemented by, for example, a keyboard, a mouse, a touchscreen, a track-pad, a trackball, isopoint and/or a voice recognition system.

One or more output devices 1524 are also connected to the interface circuit 1520. The output devices 1524 can be implemented, for example, by display devices (e.g., a liquid crystal display, a cathode ray tube display (CRT), a printer and/or speakers). The interface circuit 1020, thus, typically includes a graphics driver card.

The interface circuit 1520 also includes a communication device such as a modem or network interface card to facilitate exchange of data with external computers via a network 1526 (e.g., an Ethernet connection, a digital subscriber line (DSL), a telephone line, coaxial cable, a cellular telephone system, etc.).

The processor platform 1500 also includes one or more mass storage devices 1528 for storing software and data. Examples of such mass storage devices 1528 include floppy disk drives, hard drive disks, compact disk drives and digital versatile disk (DVD) drives.

The coded instructions 1532 of FIGS. 2, 5, 11 and 12 may be stored in the mass storage device 1528, in the volatile memory 1514, in the non-volatile memory 1516, and/or on a removable storage medium such as a CD or DVD.

Methods, apparatus, systems and articles of manufacture to facilitate sales forecasting in a manner that simplifies one or more time-consuming tasks of identifying suitable driver forecasts that may be responsible for sales activity have been disclosed. Additionally, because many different alerting methodologies are available to a market researcher, the above disclosed methods, apparatus, systems and articles of manufacture select those alerting methodologies in a manner that increases (e.g., maximizes) particular methodology strengths while reducing (e.g., minimizing) particular methodology biases and/or weaknesses. Further, example methods, apparatus, systems and articles of manufacture disclosed herein tailor the alerting methodologies in a manner that comports with a company culture and/or expected business practices so that alerts either occur (a) early enough to allow a client to react or (b) sparsely enough as to avoid inundating particular clients that are risk tolerant.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to generate an alert, comprising:
retrieving client driver control data and corresponding market triggers;
generating a client baseline profile associated with the client based on the client driver control data and a corresponding market trigger;
calculating a first probability of not taking action when action prevents a missed marketing objective;
calculating a second probability of taking action when action causes superfluous spending to meet a marketing objective; and
generating the alert based on a comparison between the product of the first probability and a cost of the missed marketing objective and the product of the second probability and a cost of the superfluous spending.

2. A method as defined in claim 1, wherein the corresponding trigger occurs prior to an instance of driver control by the client.

3. A method as defined in claim 1, wherein the corresponding trigger occurs after an instance of driver control by the client.

4. A method as defined in claim 1, wherein the action comprises at least one of an advertising campaign or a temporary price reduction.

5. A method as defined in claim 1, wherein the client driver control data comprises an instance of client-control over at least one of price, promotion or distribution.

6. A method as defined in claim 1, wherein the client driver control data comprises an instance of driver control in response to at least one of competitor-controlled price, promotion or distribution.

7. A method as defined in claim 1, wherein the cost of the missed marketing objective comprises at least one of a cost of lost share, a cost of lost margin, or a cost of lost revenue.

8. A method as defined in claim 1, further comprising calculating a ratio between the cost of the missed marketing objective and the cost of the superfluous spending.

9. A method as defined in claim 8, further comprising calculating a propensity for the client to take action based on the ratio.

10. A method as defined in claim 1, further comprising minimizing the sum of (a) the product of the first probability and the cost of the missed marketing objective and (b) the product of the second probability and the cost of the superfluous spending.

11. A method as defined in claim 10, further comprising selecting an alerting threshold based on the minimized sum, the minimized sum indicative of a net expected loss.

12. An apparatus to generate an alert, comprising:
a client history manager to retrieve client driver control data and corresponding market triggers, and to generate a client baseline profile associated with the client based on the client driver control data and a corresponding market trigger;
an action probability engine to calculate a first probability of not taking action when action prevents a missed marketing objective, and to calculate a second probability of taking action when action causes superfluous spending to meet a marketing objective; and
an alerting level manager to generate the alert based on a comparison between the product of the first probability and a cost of the missed marketing objective and the product of the second probability and a cost of the superfluous spending.

13. An apparatus as defined in claim 12, wherein the client history manager is to identify that the corresponding trigger occurs prior to an instance of driver control by the client.

14. An apparatus as defined in claim 12, wherein the client history manager is to identify that the corresponding trigger occurs after an instance of driver control by the client.

15. An apparatus as defined in claim 12, wherein the action comprises at least one of an advertising campaign or a temporary price reduction.

16. An apparatus as defined in claim 12, wherein the client driver control data comprises an instance of client-control over at least one of price, promotion or distribution.

17. An apparatus as defined in claim 12, wherein the client driver control data comprises an instance of driver control in response to at least one of competitor-controlled price, promotion or distribution.

18. An apparatus as defined in claim 12, wherein the client history manager is to identify the cost of the missed marketing objective as at least one of a cost of lost share, a cost of lost margin, or a cost of lost revenue.

19. An apparatus as defined in claim 12, wherein the action probability engine is to calculate a ratio between the cost of the missing marketing objective and the cost of the superfluous spending.

20. An apparatus as defined in claim 19, wherein the action probability engine is to calculate a propensity for the client to take action based on the ratio.

21. An apparatus as defined in claim 12, wherein the action probability engine is to minimize the sum of (a) the product of the first probability and the cost of the missed marketing objective and (b) the product of the second probability and the cost of the superfluous spending.

22. An apparatus as defined in claim 21, further comprising a net loss engine to select an alerting threshold based on the minimized sum, the minimized sum indicative of a net expected loss.

23. A tangible machine readable storage medium comprising machine readable instructions that, when executed, cause a machine to, at least:
retrieve client driver control data and corresponding market triggers;
generate a client baseline profile associated with the client based on the client driver control data and a corresponding market trigger;
calculate a first probability of not taking action when action prevents a missed marketing objective;
calculate a second probability of taking action when action causes superfluous spending to meet a marketing objective; and
generate the alert based on a comparison between the product of the first probability and a cost of the missed marketing objective and the product of the second probability and a cost of the superfluous spending.

24. A machine readable storage medium as defined in claim 23, wherein the machine readable instructions, when executed, cause the machine to identify the corresponding trigger occurring prior to an instance of driver control by the client.

25. A machine readable storage medium as defined in claim 23, wherein the machine readable instructions, when executed, cause the machine to identify the corresponding trigger occurring after to an instance of driver control by the client.

26. A machine readable storage medium as defined in claim 23, wherein the machine readable instructions, when executed, cause the machine to identify the client driver control data as at least one of price, promotion or distribution control.

27. A machine readable storage medium as defined in claim 23, wherein the machine readable instructions, when executed, cause the machine to identify the cost of the missed marketing objective as at least one of a cost of lost share, a cost of lost margin, or a cost of lost revenue.

28. A machine readable storage medium as defined in claim 23, wherein the machine readable instructions, when executed, cause the machine to calculate a ratio between the cost of the missed marketing objective and the cost of the superfluous spending.

29. A machine readable storage medium as defined in claim 28, wherein the machine readable instructions, when executed, cause the machine to calculate a propensity for the client to take action based on the ratio.

30. A machine readable storage medium as defined in claim 23, wherein the machine readable instructions, when executed, cause the machine to minimize the sum of (a) the product of the first probability and the cost of the missed marketing objective and (b) the product of the second probability and the cost of the superfluous spending.

31. A machine readable storage medium as defined in claim 30, wherein the machine readable instructions, when executed, cause the machine to select an alerting threshold based on the minimized sum, the minimized sum indicative of a net expected loss.
